(19) United States
(12) Patent Application Publication
(10) Pub. No.: US 2006/0158459 A1
(43) Pub. Date: Jul. 20, 2006

(54) Systems and methods for creating user interfaces

(76) Inventors: Stuart Harl Ferguson, Sunnyvale, CA (US); Bradley Warren Peebler, San Francisco, CA (US); Joe Angell, Jay, VT (US); Matthew Craig, San Mateo, CA (US); Gregory Duquesne, Brdeaux (FR); Eric A. Soulvie, San Mateo, CA (US); Allen David Hastings, Los Altos Hills, CA (US)

Correspondence Address: GORDON & REES LLP, 101 WEST BROADWAY, SUITE 1600, SAN DIEGO, CA, 92101, US

(21) Appl. No.: 11/186,462

(22) Filed: Jul. 20, 2005

Related U.S. Application Data
(60) Provisional application No. 60/589,997, filed on Jul. 20, 2004.
(60) Provisional application No. 60/590,886, filed on Jul. 22, 2004.
(60) Provisional application No. 60/599,993, filed on Aug. 9, 2004.

(51) Int. Cl. G09G 5/00

(52) U.S. Cl. 345/619

(57) ABSTRACT

The present invention allows users to customize user interfaces within software programs on the fly. By customizing user interfaces users can streamline their own work process, particularly when the user is dealing with large amounts of data. In addition to customizing user interfaces, the present invention also allows users to more easily select portions of an object with the select more command and to more easily enter exact numeric values with detents on mouse input.

### PRIORITY

This application claims the benefit of priority of U.S. provisional application Ser. No. 60/589,997 filed Jul. 20, 2004, U.S. provisional application Ser. No. 60/590,886 filed Jul. 22, 2004 and U.S. provisional application Ser. No. 60/599,993 filed Aug. 9, 2004 all of which are incorporated herein by reference in there entirety.

### FIELD OF THE INVENTION

The present invention relates generally to the field of computer animation software.

### BACKGROUND OF THE INVENTION

The field of computer graphics offers many challenges for software designers. The field is by its nature enormously complex and technical, and yet the best practitioners come from graphics arts and traditional filmmaking. As result the user interfaces for 3D animation systems need to be simultaneously intuitive and uncomplicated for the non-technical artist, and provide deep access to the vast amounts of detailed data that are required for exact control over the animation and rendering process. Although there is a great deal of prior art for computer user interfaces and for 3D computer animation software, all of it fails in several related ways.

The prior art is too limited in terms of the views that the user can get of their project data, and particularly the speed and fluidity by which the user can change and adjust their views. These limitations extend to the selection model, which in the prior art is ad hoc or restricted to a single data view. What is needed is a system that allows the user more flexibility in setting up their data views, and a comprehensive selection model that functions uniformly across views as well as providing additional capabilities.

The prior art leaves much to be desired in terms of easy but precise input, intuitive selection operations on large data sets, and general access to functions and controls. Existing systems always compromise between the precision of working in a planar projection versus the more free-form perspective view. Selection on large 3D data sets is particularly difficult, and all systems are too restrictive of the patterns of selections they allow. Access to functionality is limited by screen space or by restrictions on when certain modifier keys can be used. It would be very useful to have a system which addresses these issues.

The prior art makes it difficult or impossible for users to build their own interfaces. Interfaces are constructed using entirely different methods from the ones used to do 3D animation, so nothing that the user learns from their experience as an animator helps them customize their own work. Individuals and studios would like to have a method to share new interfaces and scripts in a hierarchical manner, and perhaps even to make entire salable applications by selling these specialized interfaces to other users. An ideal system would provide a consistent mechanism for performing 3D animation which can also be applied towards making new interfaces, the system would build its own interfaces that way as well, and it would also offer a method for converting specialized versions of interfaces into new applications.

### SUMMARY OF THE INVENTION

The present invention allows users to overcome many of the drawbacks of the prior art. For instance, the present invention allows users to customize user interfaces within software programs on the fly. By customizing user interfaces users can streamline their own work process, particularly when the user is dealing with large amounts of data. In addition to customizing user interfaces, the present invention also allows users to more easily select portions of an object with the select more command and to more easily enter exact numeric values with detents on mouse input.

The present invention also comprises user interfaces that utilize queryable commands and a global selection stack which allow the user to make new interfaces using the same commands they learn when using the software. It also includes the facility for these interfaces to be shared in a system of layered configs and baked into separate applications, as well as addressing many of the smaller deficiencies of dealing with 3D data on a 2D display screen, and of accessing many and varied operations.

The foregoing, together with other features and advantages of the present invention, will become more apparent when referring to the specification, claims and accompanying drawings.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 illustrates a blank display screen containing a generic viewport;

FIG. 2 illustrates a generic viewport that has been split into one main 3D viewport with several smaller viewports;

FIG. 3a illustrates a data list view in its expanded “tree” view mode which allows the user to see the maximum amount of data when the screen real estate is available;

FIG. 3b illustrates a compressed “tree” view of the data list;

FIG. 4 illustrates a selection stack in the preferred embodiment of the present invention;

FIG. 5a illustrates an object, such as a cylinder, that has a pattern of selecting polygons next to each other;

FIG. 5b illustrates the object of FIG. 6b after the user has utilized the select more feature of the present invention;

FIGS. 6a and 6b illustrate another example of using the select more command;

FIG. 7 illustrates a prior art series of commands that the user has performed and the state of the system after the user has performed undo commands;

FIG. 8 illustrates an example of branching of a preferred embodiment of the present invention;

FIGS. 9a and 9b illustrate the features of undoing a command and branching in a preferred embodiment of the present invention;

FIG. 10 illustrates commands being used to implement tool palettes;

FIG. 11 illustrates an automatic property sheet of a preferred embodiment of the present invention;

FIG. 12 illustrates another example of a property sheet of the present invention implementing mixed state;

FIG. 13, illustrates a form editor utilized in a preferred embodiment of the present invention; and

FIG. 14 illustrates configuration layering and application baking in a preferred embodiment of the present invention.

### DETAILED DESCRIPTION OF THE DRAWINGS

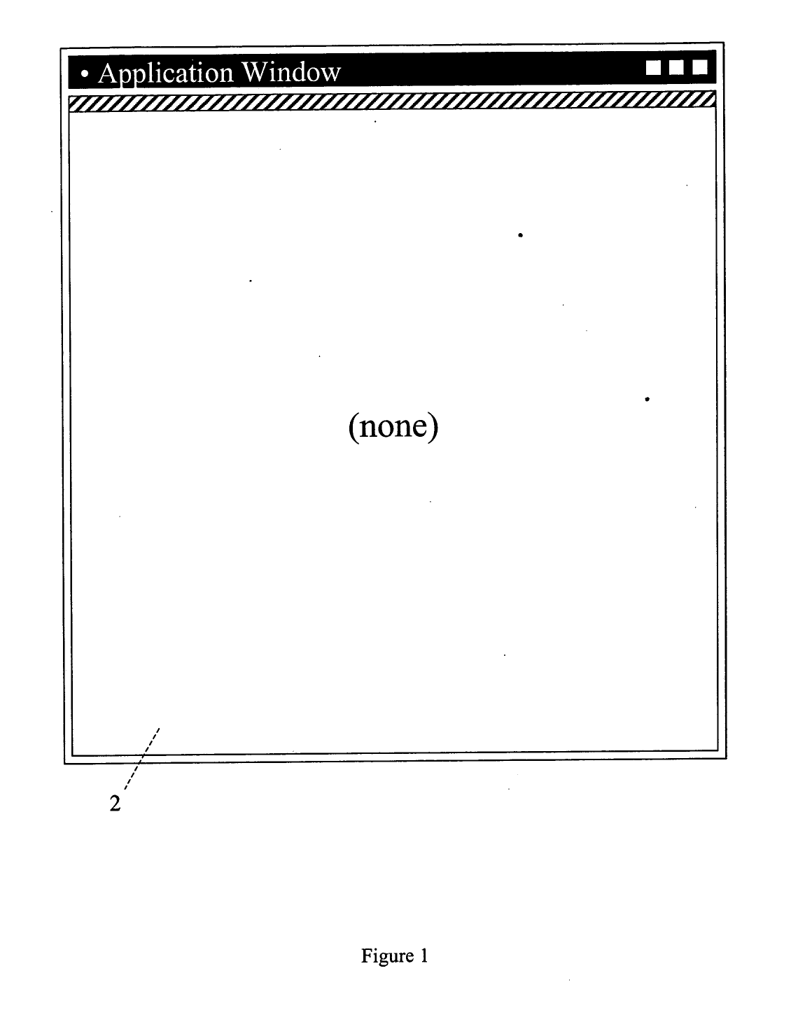

In the preferred embodiment of the present invention, a customized or personal user interface for a computer program is developed. A user of the computer program may start off with a blank display screen containing a generic viewport. FIG. 1 illustrates a single generic viewport 2 on a computer screen. A viewport is a window pane or an embedded window on the display screen which is not the same as an MDI (Microsoft® development/document interface) window. Once the generic viewport has been created, a splitting method is utilized to create the layout of the customized interface. In the splitting method, the user splits the generic viewport into as many viewports as is necessitated by what the user is doing. For example, in customizing an interface, the user starts with a generic viewport and then splits the generic viewport so that three (3) viewports are on the right hand side of the screen, one main viewport is in the middle of the screen and four (4) viewports are on the left hand of the screen. Although a total of seven (7) viewports are created, this is by way of example only and a greater or lesser amount of viewports can be created. Splitting changes a single viewport into a grid of identical viewports, mostly commonly grids with the dimensions 1 by 2, 2 by 1, and 2 by 2. The systems and methods of the present invention will be described with reference to 3D animation software, however, this is by way of example, and those skilled in the art will recognize that the principles and teachings described herein may be applied to a variety of software programs, applications and industries.

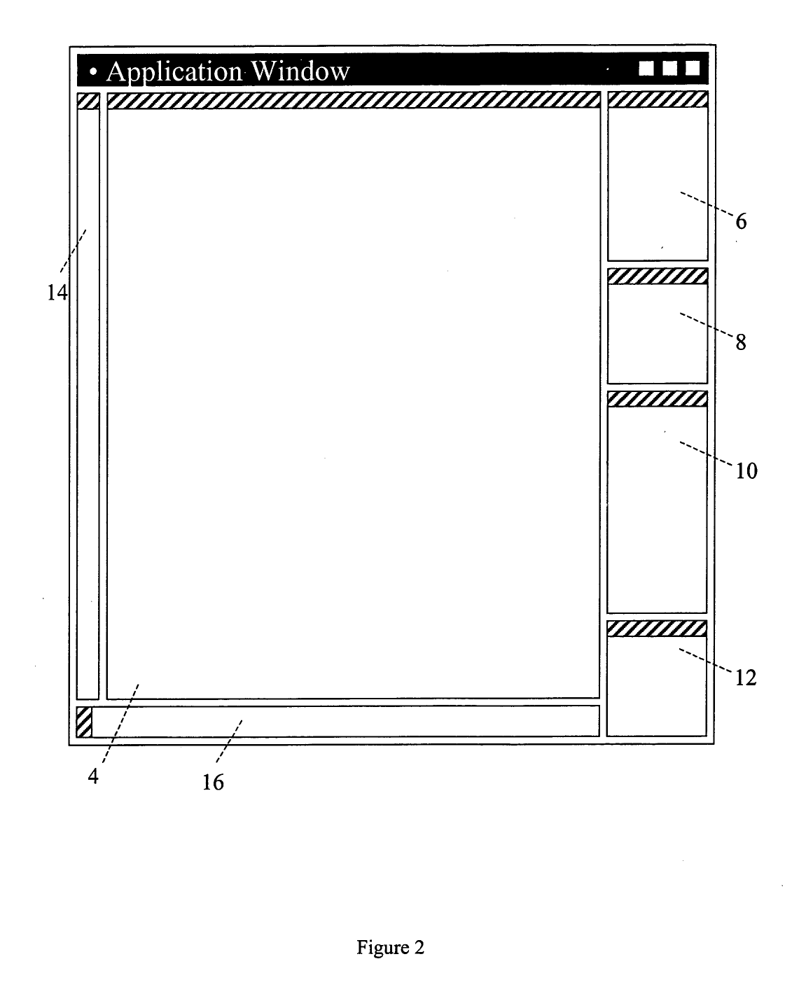

Typically the main interface is a 3D model viewport, i.e. a viewport that displays 3D animation or modeling. The viewports on the side are customized for each individual user. For example, the user could make a viewport a tool bar, a list of data, a 3D model view, etc. FIG. 2 illustrates a generic viewport that has been split into one main viewport 4 with several smaller viewports on the right hand side of the screen 6, 8, 10, 12; a viewport on the left hand side of the screen 14 and a viewport at the bottom of the screen 16. At any time, the user can decide to populate the viewport differently, such as changing a 3D model view viewport to a list of data. By allowing the user to populate or change a viewport on the fly, the user can build the user interface (UI) to accommodate the part of the animation program that is currently being worked on. In the present invention, the user can change an existing viewport to show different information by picking a menu choice or key shortcut instead of having to open up a new window for the particular information that is desired. This is particularly useful when the user needs to change viewports often. The user can detach the viewport so that it will be floating or the user can embed the viewport. Viewport layouts may be saved so that the user can recall them at a later time, or use them as the initial viewport layout when starting the application, instead of the single generic viewport.

As discussed previously, in prior art systems using floating windows with docking, if a user wants a different viewport, the user must detach the viewport or destroy it so that a new floating window could be dropped in to replace the floating window thrown away. In 3D animation, the user utilizes numerous graphic interfaces and it is difficult for all the necessary interfaces to be displayed on the computer screen at the same time, so it is very important in graphic arts that the user can change the interfaces rapidly so the user can quickly get to what is needed without having all the interfaces open at the same time.

Viewports in the preferred embodiment have the ability to reconfigure their contents as the user changes their shape and size. This is called “morphing user interface” or “morphing UI”. A viewport may contain a tree, for example, which lists the contents of some aspect of the user's project. If the user sets the viewport to a small size on the screen, the tree becomes less useful since only one or two lines may be visible at once, and the user would have to use a tiny scroll-bar to find the item of interest. Prior art systems have no way to prevent this except by constraining the viewport to a minimum size and not allowing the user to make the viewport smaller. In the preferred embodiment of the present invention, the contents of the viewport automatically change so that the UI can still be used at a smaller size albeit less easily. For example, as the viewport gets shorter, the list may change into a fixed set of popups which open when clicked on to allow the user to view and select from parts of the list. As the viewport gets even smaller, the vertical array of popups changes to a single popup and a set of small choice buttons to let the single popup serve the same purpose of the list of popups. As another example, the user may expand the viewport containing the list horizontally, making it much wider. In this case there is even more space for UI features, so the list may add columns so that properties that were listed under main entries in the list are now shown as a horizontal table. This makes better use of the available space and adds new features to the same interface. Although these are specific examples in the current embodiment, this same concept of morphing UI could be useful in a wide range of other applications, and that the rearrangement of viewport contents to utilize their available space could be done in a great many creative ways.

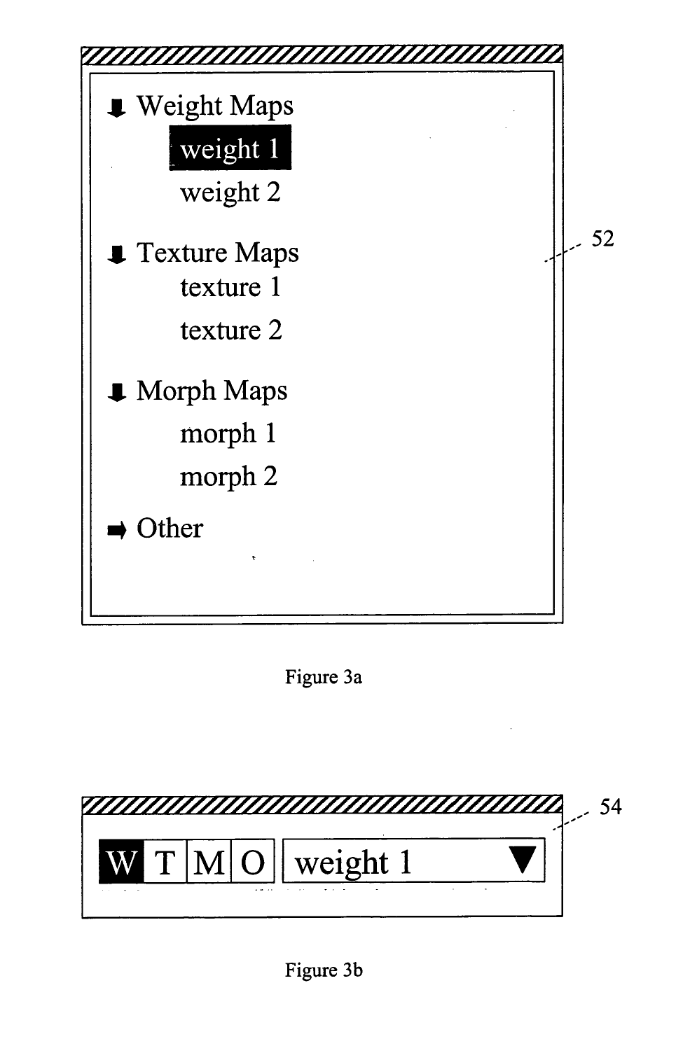

FIG. 3a illustrates a data list view 50 in its expanded “tree” view mode, which allows the user to see the maximum amount of data when the screen real estate is available. “Tree” views are less desirable when the viewports are reduced in size. The data list view allows the user to choose between several items such as weight maps, texture maps and morph maps. These items are by way of example only and numerous other items may be displayed. FIG. 3b illustrates a compressed “tree” view of the data list that has utilized the morphing UI feature discussed above. Each category in the tree becomes a separate pop-up, which provides the user quick access to all data in a much cleaner interface. The viewport 54 has reached its minimum size and cannot be compressed any further. This viewport 54, utilizing the “morphing UI” option, automatically collapses into a new compressed viewport that provides a single pop-up with filter buttons to allow the user to quickly navigate large data lists even within this slim line interface. The user converts the viewport 50 into viewport 54 by simply changing the available size of the viewport, and the contents of the viewport adjust automatically.

The present invention also comprises user interfaces that utilize a global selection stack, which allows the computer program or system to track multiple selections of different types across the multiple viewports. For example, if the 3D model viewport is illustrating a three-dimensional object, such as a sphere, the selection stack allows the user to select the vertices, edges, polygons or materials of the object. The selection automatically focuses on what the user is working on. The selection stack contains an ordered list of various types of elements that can be selected, and are defined by various subsystems, which specify a chunk of data called a packet that defines what represents a single unit of selection. For example, the vertex selection contains a pointer to the mesh and a pointer to the vertex of the mesh. The selection is maintained in this stack form so that the recently selected types are near the top of the stack and contain the list of packets of the selection. Subsystems of the application determine what types the user is interested in by looking at the order of the various types in the stack, and whether there is anything selected in that state. For example, a display could be able to list vertices, edges, polygons or materials. The display queries the selection stack to determine which one, out of the vertices, edges, polygons, and materials, is higher in the stack and lists only that selection type. If the user has selected “materials” most recently, “materials” would pop up from wherever it is in the selection stack and be placed at the top and material selections would now be listed in the display. If the user is switching between “polygons” and “materials”, the order is just shuffled in the selection stack. In the prior art, selection is managed in applications by a special purpose mechanism. The applications have a specific mode, or a specific state that is maintained and a mode that switches between the different types. In the present invention the selection “mode” is implicit in the order of the selection types.

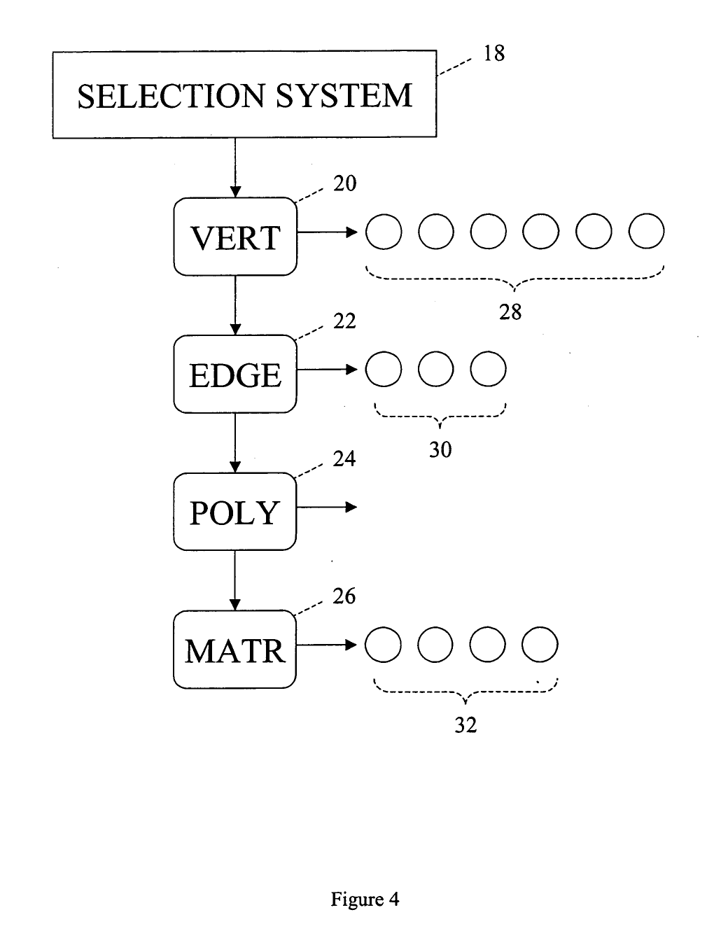

In an additional embodiment, the present invention can utilize different views of the selection stack for different subsystems, i.e. different parts of the program or different viewports. Different viewports can look at different types of selections and different subsystems can be shown different selection stacks. It is possible to put a filter on a subsystem that filters the list in the stack in a certain way so that the subsystem doesn't see some selections or the subsystem sees the selections in a different order. FIG. 4 illustrates a selection stack 18 comprised of four packets, 20, 22, 24, 26. By way of example only, 20 is vertices, 22 is edges, 24 is polygons and 26 is materials. If polygons are extremely important to a subsystem, polygons are always at the top of the stack. If edges are extremely important to another system, edges are always on the top of the stack for that particular subsystem. As such, two subsystems can see two different views of the stack depending on what is most important to each of the subsystems. Each of the packets may contain references to objects 28, 30, 32 associated with the packet. This information can include a description of the object. Even though the polygon selection type 24 contains no selected elements, it is maintained in the stack because its order is important.

It is possible to use this selection stack (general mechanism) for temporary selection changes. In other words, changes can be made to the selection stack in a temporary way so that the subsystem can go back to the way the stack originally was by discarding any temporary changes. This is useful for scripts, which are an important part of 3D animation software. A script is like a program which executes commands to perform a custom function, and when a script runs it needs to select some items so that the commands will operate on the target of the script. But the user does not want their selection state to be damaged by running a script, so the script needs to run in a nested context so it can change the selection and then restore the selection back to the way that it was before the script ran. In other words, the system is remembering what the selection stack initially was, completes the required tasks and then throws away the altered selection stack and returns to the default.

Another feature of the selection stack is lock selection. Lock selection locks a specific viewport to a certain state of the selection stack so the only items viewed on that viewport are what the user had selected at that point. Normally two viewports have the same view of the selection stack, so both of the viewports will be updated as the selection changes. However, for example, if a user wants a viewport to always display a specific UV map, the user can lock the selection for that viewport so that the UV map which is currently selected stays in the viewport. Locking the selection for a particular viewport does not prevent the user from changing the selection or elements in any other viewports. If the user changes the UV map selection, the viewport which is locked will not see the change and will still see the original selection, while the viewport which was not locked will update to track the new selection. Allowing viewports to have different or customized elements allows the user to bring up two different views of the same object. Essentially each viewport can have its own elements displayed. There are potentially a lot of different elements that can be displayed in a viewport. In a preferred embodiment of the present invention, filters can be applied to the selections. So, if for example there was a very long list of elements, a filter can be applied so the user only saw a subset of the elements that is of special interest to them. Another option available with the selection stacks is to insert a time packet, which will allow a programmer or animator to animate over time. In prior art systems, applications have global times that are a time slider element that is part of the application global state. In this invention, viewports may have different times by using the normal selection locking.

Some options available to the user for general viewports are the following:

1. Lock the selection as described above;

2. Filter the selection as described above; and

3. General animation capture
a. as a character is being animated; the user can play the animation to see what it looks like in real time, provided the system can play the animation at sufficient speed.
b. When real-time playback is too slow, many programs also have the ability to record frame-by-frame animation to play it back as a movie. In a preferred embodiment of the present invention, this can be done for any and all viewport types, so the user could turn on a general viewport feature to give the user an animation playback bar and then the user could record in the contents of the viewport. The recording feature of the present invention also is facilitated by the locking feature of the selection system. The user is able to record not just the 3D view as in prior art systems, but anything, even data lists or property sheet.

While working in 3D, the user can also work in a wire frame view of the object which is preferable, however, due to the jumble of wire frame lines, it can be difficult for the user to see the object. In another embodiment of the present invention, a user can oscillate the 3D object. The oscillate function is based on the vector of a mouse gesture, so depending on how fast the user moves the mouse and when the user lets go of the mouse, the object will either rotate a tiny angle range or a large angle range. Oscillating enhances parallax, allowing the user to see what part of the wireframe is in the front and what part is in the back. Prior art systems allow oscillation by fixed amounts and in a fixed direction, however, not controlled by mouse action.

Working in 3D space, any 2D mouse input needs to be converted into a 3D location or vector, which typically involves picking a plane in 3D which corresponds to points on the screen in 2D—essentially what axis it should be acting on. In prior art systems the user can use the view projection or a fixed working plane which is manually selected. The method and system of the present invention allows this to be chosen automatically from among the three major axis-aligned planes based on the position and orientation of the user's view into 3D space. In one view orientation, the Z-Y plane can be shown as predominant, however as the user rotates around, the axis snaps and becomes the X-Y plane. The location of the plane is chosen to pass through a nice value in the other axis, near the center of the user's view point. The user has constant feedback about the current working plane by seeing a grid, which changes as they rotate, and tool actions and primitive handles are constrained to this plane.

Typically 3D users like to put images in the background, so there would be a front image, a top image and a side image. In prior art systems, if the user wants to have images in the background, a quad view (orthogonal projections) must be utilized to view them. In a preferred embodiment of the present invention, the user can utilize one viewport and see the front image of the face on the X-Y work plane and then rotate the view around so it snaps to the view of the side of the head when the work plane changes to the Z-Y plane. The user could also rotate the view to see the top of the head; a quad view is not needed. In some prior art systems, the user can get some of this functionality by mapping their image onto a 3D model, but without the ability to see only the image in the most relevant work plane. The two main features of this portion of the present invention is visualization of the work plane that auto snaps and the other is attaching images to it.

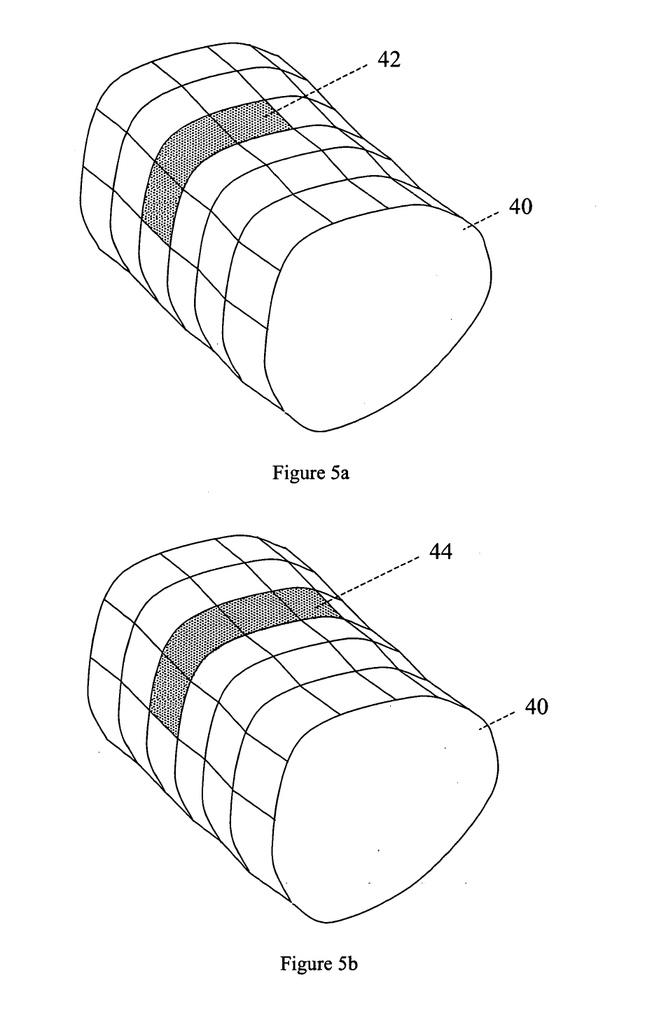

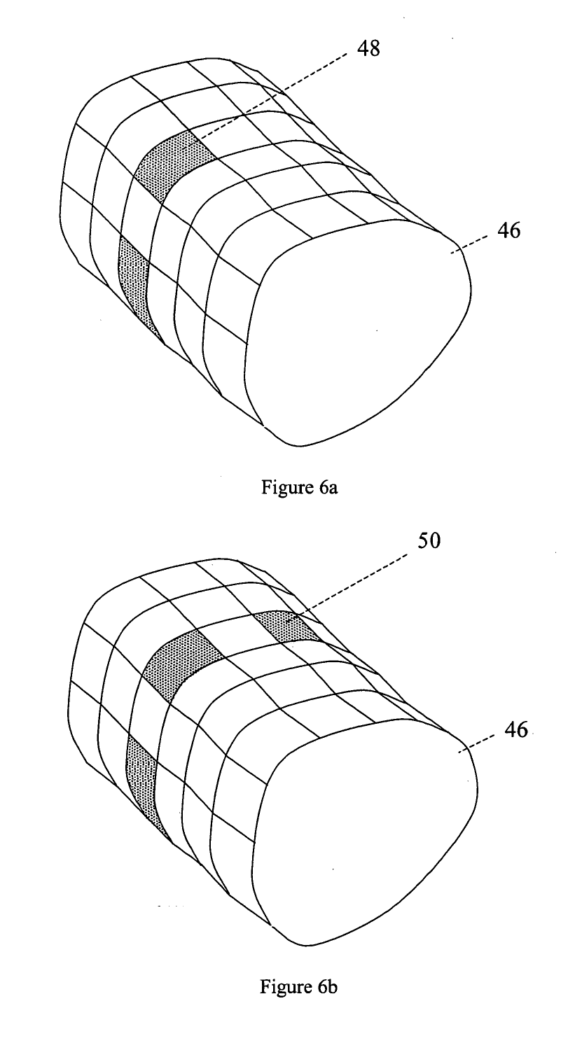

Additionally 3D users or artists typically have to select large quantities of data. In a preferred embodiment of the present invention a select more feature is utilized. The select more command utilizes a list of heuristic patterns that it compares against the most recent selection. It selects the next element in the pattern that best fits the current conditions each time the select more command is selected; the command looks for a new pattern, which is often the same pattern since the last select more command extended it. FIG. 5a illustrates an object 40, such as a cylinder, that has a pattern of selecting polygons next to each other 42. For example, if the selection mode is in the polygon mode and the user has selected three polygons right next to each other, upon using the select more command, a fourth polygon 44, next to the three polygons 42 is selected. (See FIG. 5b) FIGS. 6a and 6b illustrate another example of using the select more command. The select more command looks at the last two polygons 48 selected of an object 46. As can be seen in FIG. 6a, two polygons are selected with an unselected polygon in between. By utilizing the select more command, another polygon 50 will be selected with an unselected polygon in-between. Other patterns can include on top of each other and across an edge, or rows of vertices, or edges touching end to end. The present invention also comprises a select less command, which unselects the most recent selection. The patterns the commands read are extensible over time so the command can have more and more patterns. Although these commands are illustrated using 3D animation software, however, this is by way of example, and those skilled in the art will recognize that the principles and teachings described herein may be applied to a variety of applications such as spread sheets where the user may decide to select every other cell or every other third cell.

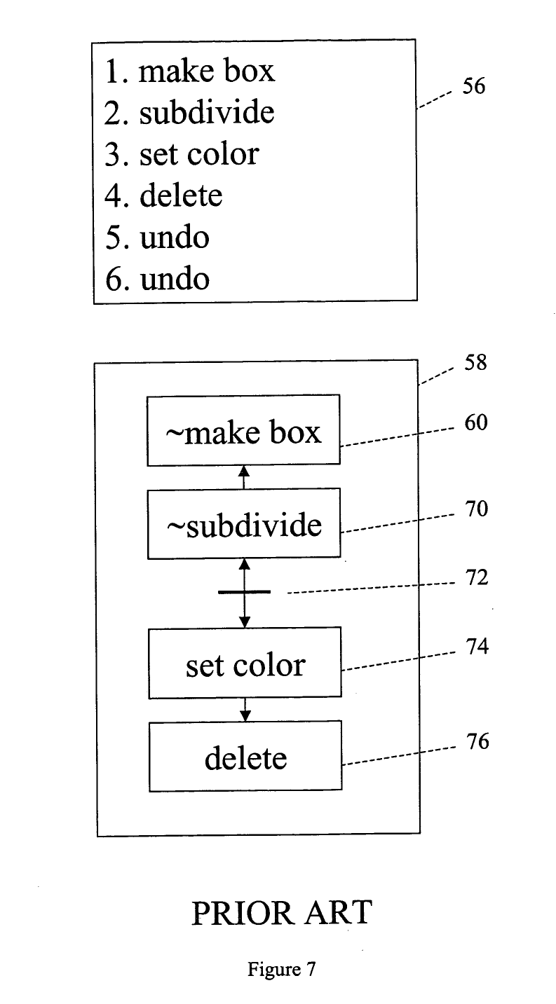

The system and method of the present invention also allows commands to be undone. This is accomplished by the system recording the state changes caused by the user's previous actions in a manner that allows them to be reversed. FIG. 7 illustrates a series of commands that the user has performed and the state of the system after the user has performed two (2) undo commands. The series of commands the user has performed are: (1) make box; (2) subdivide box; (3) set color of box; (4) delete box; (5) undo delete; and (6) undo set color. The user is left with a sub-divided box and the pointer is at the subdivide command, which is the present state of the system. Each time the undo command is used; an action is reversed and becomes an inverted action that is called a redo. In this example, set color of box and delete box are redoes. If a user does a redo, the user can step forward and reapply that change which changes the pointer indicating where the user is. This is typical in many prior art systems. The state of the system after the undos is represented by the undo system state 58. Past actions that are available for undoing are make box 60 and subdivide 70. The undo system state 58 also indicates the present state 72 of the system. Future actions for redo are also available to the user. These future actions are set color 74 and delete 76. The present invention takes the undo command one step further by allowing branching.

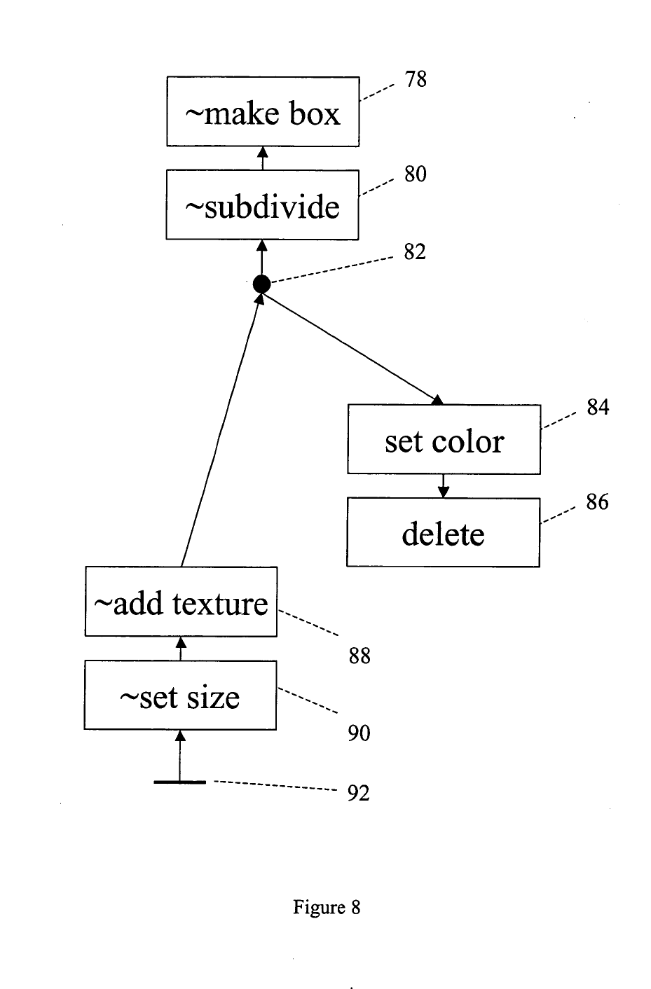

FIG. 8 illustrates an example of branching of the present invention. The user has the ability to go from its present location 72 in FIG. 7 and perform additional actions such as add texture to the box 88 and set the size of the box 90 leaving the user at a new present location 92. From the new present location 92, the user can perform an undo action for set size 90 and an undo action for set texture 88 which would leave the user at the branch point 82. If the user is located at the branch point 82 and the user wants to be able to redo specific prior actions, but also wants to take a different path and go off and do something different, the user can do that. The system takes the set of redoes and stores them in memory so the history pointer is located at the branch point 82, and the user can start off in a different path. As can be seen from FIG. 7, the user undid the action for delete 86 and undid the action for set color 84; these two actions were then stored in memory for possible redo actions and the user is left at the branch point 82. The possible redo actions are shown in FIG. 8 as redo action for set color 84 and redo action for delete 86. It is analogous to traveling back in time and trying something different and then coming back to the original point going forward again on the old path. This all works because the system performs the reverse of all the actions to get back the system state back to where it was before the branch. Once back to the original system state, the system can go forward. This mechanism is used internally for undoing during interactive tool operations.

In a 3D animation program, the user needs to be able to change parameters numerically. For example if the user is creating a box, the number of segments in the box is a parameter that the user may decide to increase. As the user is increasing the number of segments, the system fires the command to set the number of segments over and over again with each new intermediate value, but on the screen only one command is seen because the segments are increased through a process called re-firing. Generally there are numerous buttons displayed on the user interface that are directly connected to commands, and all changes to the system state are done through commands. In the example above, there is a specific command that will be fired to change the number of segments. If the initial number of segments was two (2) and then the user drags a slider or other control to change the number of segments to three (3), then to four (4), and finally to five (5), what happens in the system is that the command to change the number of segments gets fired three (3) times. Each time the system undoes the previous command which reverses the function of that command, reverting the parameter to its previous value before the command is reapplied again with a new value. This is re-firing. The user only sees the final result and not all the intermediate commands that were executed to achieve that value. Prior art command-based systems handle this by using a special code path for interactive changes that is not the same as the command path. Only after the value has been chosen interactively does the command path get used. In some cases the command path is bypassed entirely and a synthetic command which was never actually executed is shown to the user.

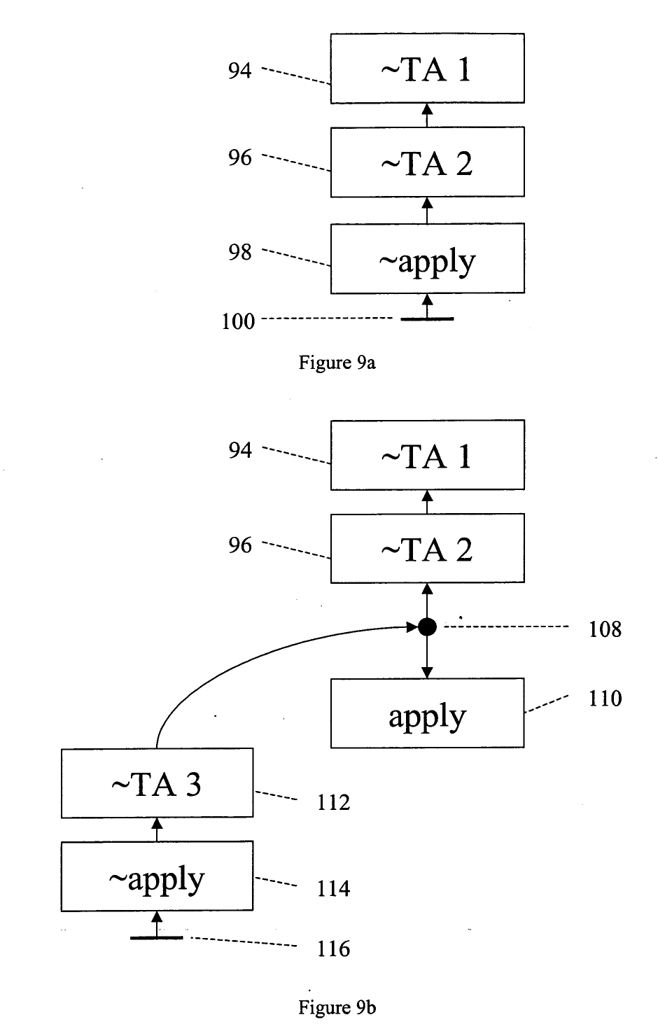

Tools are objects with attributes and the attributes determine what the tool does. The user will set the attributes of the tool and then apply the tool to alter their mesh or model. FIG. 9a illustrates tool attribute changes TA1 94 and TA2 96 that the user has performed followed by an apply command which updates the model. The user is located at present location 100 and in order to interactively adjust tool attributes they will have to perform an undo action for apply 98, make tool adjustments, and fire apply again. In the prior art utilizing a standard undo, the apply command is going to lose the old redo path because the system will not store it in memory. In order to overcome the deficiencies of the prior art, the present invention inserts a branch point 108 illustrated in FIG. 9b. From the branch point, the user performed an additional tool adjust 3 (TA3) action and an apply action to be left at the new present location 116, which has the result of the user's change to the tool attributes. From the present location 116, to get back to the original location of the branch point 108, two steps are undone (undo action for an apply command 114 and an undo action for a tool adjust command 112 (TA3). From the branch point 108, the user can either perform new commands or can redo the apply command 110.

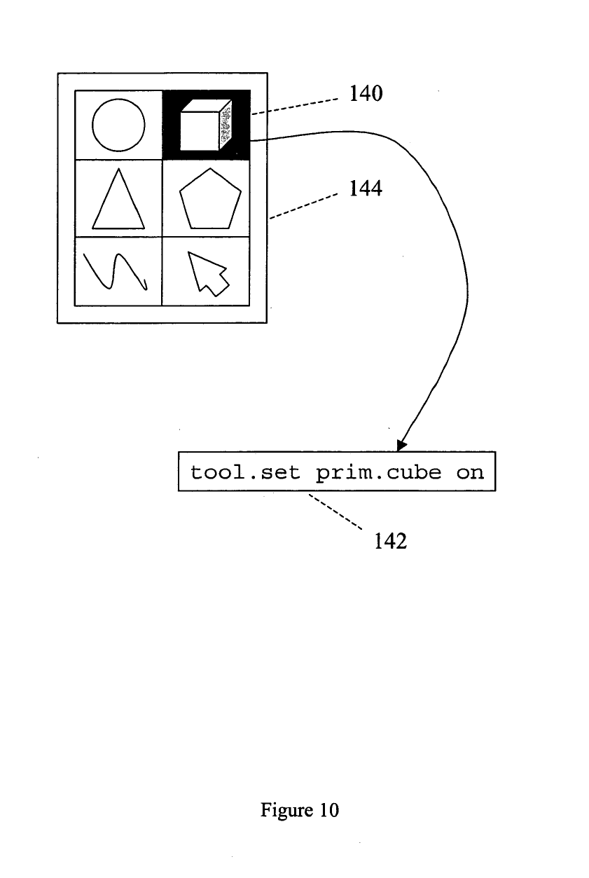

In another embodiment of the present invention, commands are utilized as complex objects with specific properties to facilitate creating the entire application interface easily and highly customizable by the user. For example, a system contains a tool palette 144, which is comprised of buttons for a cube, circle, triangle, pentagon, curve and a selection arrow, which are each connected with a command that gets fired when the button is pressed. Buttons can highlight when states are set if the command that sets that state is designated a toggle command. In this example, a toggle command is used to turn on and off tool states and have the button highlight to reflect that state FIG. 10 illustrates the cube button 140 in the “on” position. Upon selecting the cube button 140, a command is fired. The command that is fired is “tool.set prim.cube on” 142. Essentially each command has a series of arguments, such as argument 1, argument 2, etc. and each argument has specific data types. A toggle command is a command that has a specific argument with a toggle value. With such commands one argument can be specified as a toggle and it has an “off” value specified as well. Unlike prior art systems, the values of the commands in the present invention can be queried. The result of the query of the toggle argument determines if the button has a highlight or not, as well as what command is fired when the button is clicked.

A toggle argument is always a queryable argument. In the present invention, the command system can ask the command for the current system value of a queryable argument and, if this is a toggle command, the value can be compared to the off state. If it is in the off state, it doesn't light up the button. If it is not in the off state, it does light up the button and if the button is lit up, when the user presses the button again, the command is fired, but with the toggle argument having the off value; this turns the button off. FIG. 10 illustrates the “tool.set” command followed by the name of a particular tool and the second argument of the command is the mode and that is on or off. If the system queries the command for the present value of the mode argument, the command will inspect the system state and return a value based on the tool's current mode. For example, if the prim.cube tool is currently on then the mode query of the “tool.set prim.cube on” command will be “on”. The button will show highlighted because the mode is not in the off state and the next time the button is pressed the command “tool.set prim.cube off” is fired to toggle the state to off. If the mode was equal to the off state then the command “tool.set prim.cube on” 142 will be fired exactly as specified to turn it on. Another example of a toggle command is the vertex selection mode command, which is triggered by a vertex button. The command for the vertex command is more general, select.typeFrom, which is followed by several specific arguments. As with the command described above, the command has a toggle value which allows the button to highlight, although firing the command with the off value does not actually toggle that state, but in this case does something different. The state is changed by firing a different command such as the polygon selection mode command.

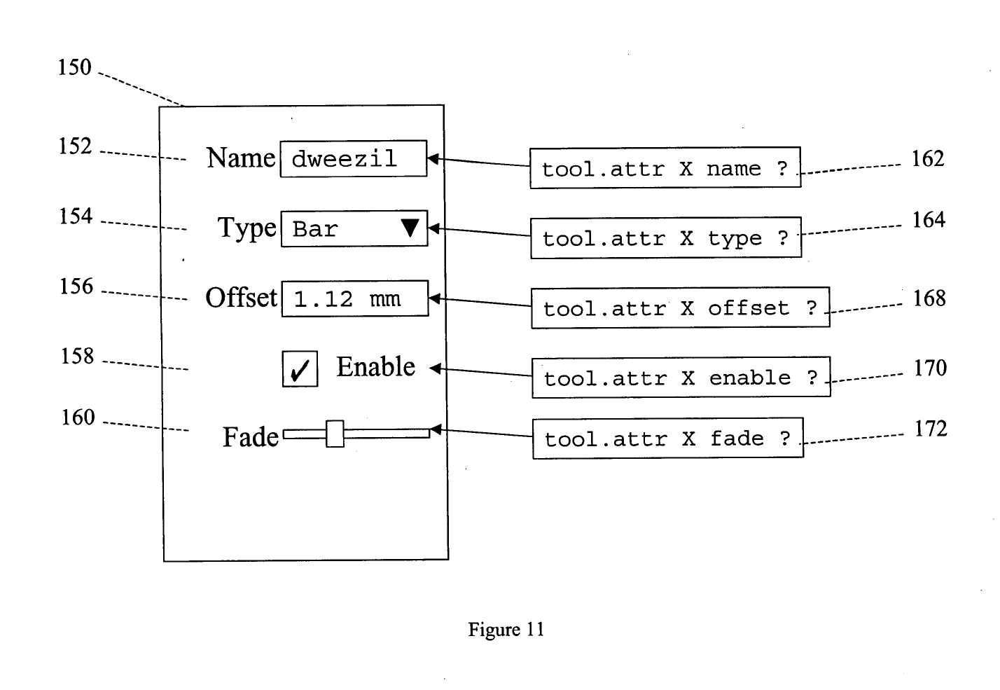

The ability to query commands in the present invention also allows the user to build an interface with controls that display current values and allow them to be edited, all while using only commands. See FIG. 11. Unlike the prior art systems, attribute control form interfaces in the present invention are built entirely by composing commands together. A very general command used for building tool property sheets is “tool.attr name:string attr:string ?value:*”. The first argument of the command is the name (a string) and there is the attribute name (another string) and then its value (variable type) and the value can be queried (the leading question mark). In this example, the first argument is the name of the tool, the second argument the attribute that the user is interested in of that particular tool and the third argument is the value for the attribute. The variable value type allows the command to determine the data type for the attribute based on the other arguments to the command and therefore the kind of control a specific command will need. For example, the user can access the radius of an object utilizing the tool.attr command with a question mark: “tool.attr prim.sphere radX ?”. Then the system of the present invention can check the type of the argument represented by the question mark. In this case it knows the type for the radX attribute of this tool is a distance value so the system creates an edit field for distances which can then be queried to get the current value to fill in the field. If the user enters a new value in the edit field the system fires the command with the new value in place of the question mark to change the radius of the object. So, it is basically all one mechanism that allows the interface to function.

Command query allows for multiple values, so for commands which support multiple selections the command system can query all the values related to the selection. For example, a property sheet 150 is shown in FIG. 11, which illustrates examples of queryable values. The property sheet is comprised of a name text input field 152, a type popup choice input field 154, an offset numeric input field 156, and enable checkbox input field 158 and a fade slider input field 160. Each of the fields has a command associated with it. When the name is entered, “dweezil” in this case, the command “tool.attr X name ?” 162 is fired with the name in place of the question mark—i.e. “tool.attr X name dweezil”. When the type is entered, “bar” in this case, the command 164 is fired as “tool.attr X type bar”. Offset causes the command “tool.attr X offset ?” 168 to be fired. Enable causes the command “tool.attr X enable ?” 170 to be fired. Fade causes the command “tool.attr X fade ?” 172 to be fired.

In another example, commands which alter the material color of an object affect all the selected materials at the same time in the same way. If three materials are selected with different colors, the command system will query the value of the current color and get three different values. In that case it will show the control to the user in a “mixed” state indicating there is no single current color. If the user alters the color then the command is fired with the new color that is then applied to all materials in the selection. Subsequent reading of the argument value gives all three values the same and the control can show a consistent current value.

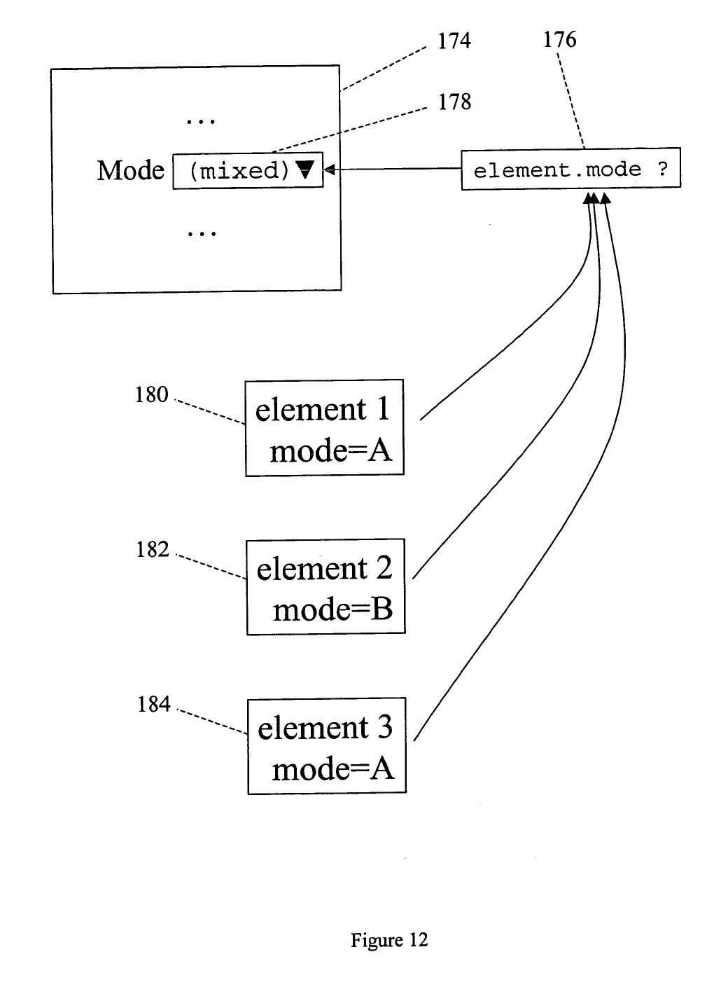

FIG. 12 illustrates another example of a property sheet 174, which is comprised of a popup choice input field 178. The property sheet allows for multiple values, so for commands which support multiple selections the command system can query all the values related to the selection. For example, the command could alter the mode setting of an element, which would cause all the selected elements to be affected at the same time in the same way. If three elements (element 1 with mode A 180; element 2 with mode B 182; element 3 also with mode A 184) are selected, the command system will query the value of the current mode setting and get three different values. In that case it will show the control to the user in a “mixed” state indicating there is no single current mode setting. If the user alters the mode setting popup then the command 176, “element.mode ?”, is fired with the new mode that is then applied to all the selected elements. Subsequent reading of the argument value gives all three values the same and the control can show a consistent current value.

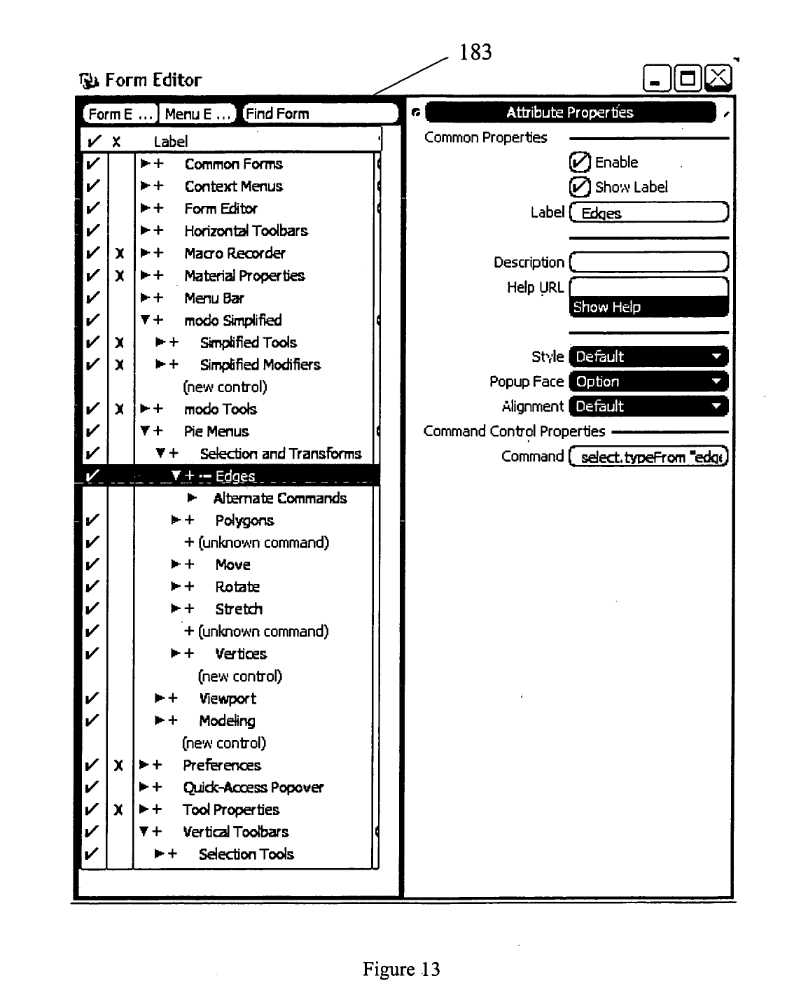

Turning to FIG. 13, a form editor 183 utilized in a preferred embodiment of the present invention is illustrated. The form editor is essentially a big tree of nodes, where internal nodes are groupings or layouts and leaf nodes are controls associated with commands. The X's in the second column of the form editor mean that these top-level forms can be used to populate a forms viewport. This form editor is utilized to create different form layouts with different settings and controls in them. All the chosen forms show up in a designated forms viewport, either sequentially, in tabs or other grouping, and as affected by the current state of filters. The setting on each particular viewport shows what the contents of the toolbars in the viewport are. The application menu bar is built the same way, with grouping nodes as the headings and sub-headings and commands for the menu options. If a command in the menu bar contains a question mark, then a list of options for that argument may be automatically generated as a sub-menu. Context menus are also built the same way. An example is a command history viewport, which has numerous menus, such as menus for the script editor. The script editor has numerous different elements that the user can click on. Essentially the script name has a whole set of menus that come up based on different key combinations. So, for example, if the user places the mouse cursor over the name of a script, the user can use the right mouse button to get a context menu, which has numerous commands that are going to operate on the script. These menus are built as forms and can be assigned to mouse buttons and qualifier keys by the user.

In a preferred embodiment of the present invention, filters are utilized to change interfaces dynamically. As the user switches tools, the user sees different controls appear. The filters allow the interface to show what is most relevant. For example, an interface containing the tool properties form contains several tool properties in the same grouping. Each sub-form has a filter on it, and the filter makes the tools form valid only when that particular tool is selected. So the filter essentially reads the selection system and decides when specific parts of the overall form should be displayed. Context menus in the interface change based upon filters. The filter lets controls and forms through and filters other controls and forms out unless certain states are set.

In a preferred embodiment of the present invention, scripts are utilized as a way for users to put together a sequence of command that will be fired either the same way every time or based on the current state of the application. A scripting language, such as Perl, which is an interpreted language, can run within the system of the present invention and allows the user to write scripts. This is consistent with prior art. The present invention adds the ability for scripts to query commands. If commands are queried, the script receives values back about the current state of the application which are then used by the script to perform tests or computations. The script can execute a command such as “tool.attr prim.sphere radX ?”. Utilizing the query function provides a result or value back, such as a single radius value, or multiple values in a list if the command requires. The script can also change values by firing commands, much the same way that form interfaces do. The invention differs from prior art in that it allows the same commands that would change the state of the system to query that same state.

In prior art systems keys are utilized for alternate commands, that is holding down different qualifiers can make different things happen with the same key. However, the present invention extends this function to mouse clicks on buttons. For example, in the prior art the X key might activate the box tool and the CTRL-X key might make a unit cube, so the user can hold down a control key to get a unit cube but only using keys. In the present system, the user can do this with a button as well, so holding down CTRL and clicking on the box tool button would make a unit cube rather than activating the box tool. As another example, a button can be set up to select the move tool, that is a tool which moves objects, while the SHIFT key on the same button selects a different tool for soft drag, ALT provides a soft move and CTRL is an element move. The icon and text on the button face change as each qualifier is depressed, allowing the user feedback about which tool will be selected for which qualifier, which is useful when users can't remember as often happens with keyboard shortcuts which have no such feedback.

In prior art systems mappings from keys to actions are utilized as keyboard shortcuts. In other words, pressing a key performs an action that might be in a menu or button palette. If a button on a tool palette or an option in the menu matches the same action, the keyboard shortcut is displayed in the interface. In a preferred embodiment of the present invention, keys are mapped not only to commands but to commands with specific arguments, and pressing the key fires the command. If the user presses the key then the command is fired on the keyboard “down” event, just as if the user had clicked on the equivalent UI button. If the key is mapped to a toggle command, then when the user presses the key, performs certain activities with the mouse—such as clicking down a mouse button and dragging—and then releases the key, the key fires the command again on the key “up” event to toggle the command state. This is a quick way of performing an activity temporarily and then turning it off again. Unlike prior art systems that utilize time for toggle keys, that is tapping based upon time, the system of the present invention utilizes a method that detects mouse action vs. the absence of mouse action. This allows the user to perform mouse interactions using a desired state without setting the state permanently, since pressing the key down toggles the state on, and releasing the key after performing some mouse interaction toggles the state off.

Configs are files containing settings for the application. The system of the present invention has a high degree of flexibility and customization, allowing users to create their own layouts, their own tool bars, their own menu bars and all of that gets saved to their config. The config system is used both for resources, which are the elements to build up the basic interface, and for the elements that the user creates, which are layered together to build the running application. That the fact that the configs provided as resources and the ones the user creates are identical in form makes the layered configs especially powerful. The invention utilizes a specific method of layering using XML config files, which consist of a hierarchical database of atoms, hashes and lists. All the elements of each layer in the database may enhance or replace elements at lower levels.

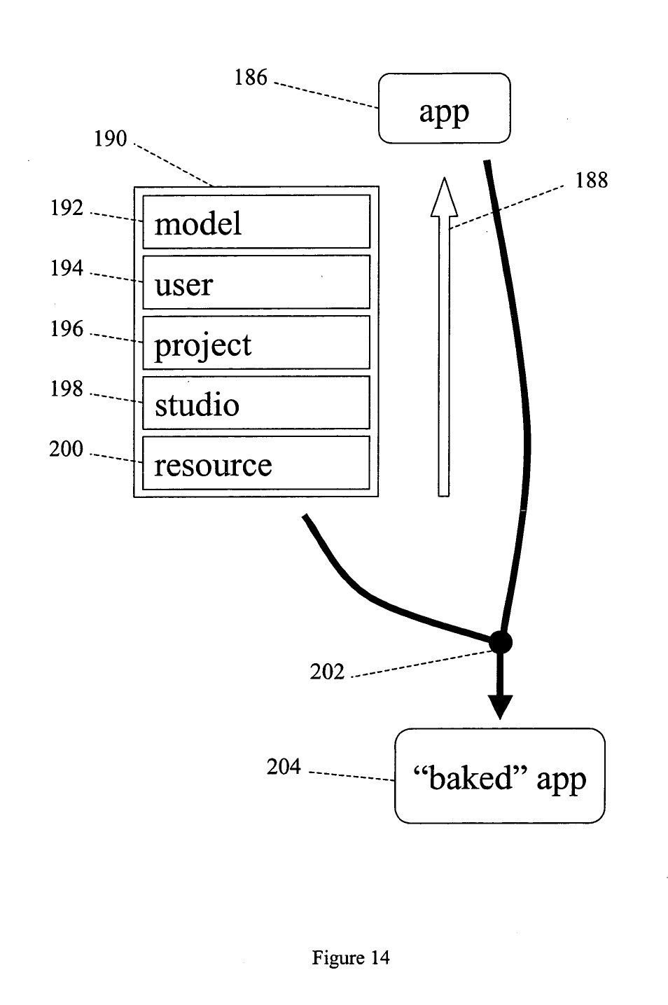

Application baking allows the whole infrastructure of the present invention to be utilized for other purposes. When the system starts up normally, the configs that are located in the resource directory and other locations are utilized. In a basic application, the user has a config and then there are resources, which together make up the layered configurations. Turning to FIG. 14, a non-baked application 186 comprises the resources of the application—all the button imagery created, the layouts, the keyboard mappings, all the command names. Essentially all the resources are down at the bottom layers and the user information is all at the top layers. The way layering works is that if the user changes anything, the user's information takes precedence. If the user changes the basic layouts of the system and saves them as their own, then the system no longer sees the layout in the resources, and the user sees the one in the user config 190. The layering employs an override mechanism 188. The config layering 190 can include several different layers with distinct purposes which starting from the most specific includes a model config layer 192 (config data in each specific document file itself), a user config layer 194 (for each user based on logon), a project config layer 196 (selected for a specific movie or advertisement contract), a studio config layer 198 (specific settings that an entire studio would provide) and a resource config layer 200. If the user has config settings the user has created and wants to share, the user can save them out as another config file and another user can add it to their layering. A company that has purchased this system can layer the system for its own purpose. The company might have configs where all of their standard directories are mapped a certain way and buttons for doing special effects within the company itself, for example their own plug-ins. Furthermore the company or studio might tailor the system for particular projects. As such, there would be a set of configs for that project so that the system can have layouts or tools especially useful in that context. These overrides can be overwritten again for a specific model or scene which has its own configurations that are loaded with the file the user is going to work on, for example a given character. This file might also contain configurations, commands or special rigs, toolbars or something to control the expressions or things in the file by not generally useful and then that would override the original settings. The user would get all these things layered into their application and constantly changing as they loaded different files and moved from project to project.

The present invention utilizes a technique called application baking. Application baking is a concept related to business development for branching out into other markets once a user has created a set up that they like that is specialized to a subset of 3D modeling, such as jewelry design. For example, a user can purchase the system of the present invention, which is a 3D modeling program, and configure the system to design jewelry, such as ring settings. If the user creates a specific set of tools for that and has stripped down the interface, this newly created system or application can be baked. When baking a program, the original application is taken along with the user's configurations and both of these are compressed or merged into the baked application to create a single specialized application; this is called the backing process 202. When this application is baked it cannot be reconfigured to do other things. The baked application 204 uses the technology of the present invention, but it is much more simplified and specialized. The number of features from the full application that are used in the baked application might determine the license fee or royalty for selling the baked application.

The present invention utilizes popovers, which are just a form, menu or other viewport that comes up on demand and is dismissed in a specific manner. Popovers can occur virtually anywhere and there are multiple ways to summon a popover. One way to summon a popover is through a keyboard shortcut. Another way to summon a popover is by clicking on a button. A popover can also be summoned by shift-clicking and then pressing a tab in a viewport, and that shows the tab contents for quick access. Finally there is a method for summoning if the user interface gets compressed so icons can no longer fit and a “>>” button will appear that will summon whatever has been omitted from the interface for space reasons inside the popover. A popover is one thing that can be used in many different ways to streamline the ergonomics for the end user.

The present invention also utilizes a roll-off dismissal. In prior art system, things that look like popovers of the present invention will dismiss or disappear when the user clicks. In the present invention, the popover stays up until the cursor of the mouse is moved off of it, which is the dismissal behavior. The advantage of this feature is that the user can make as many changes as is necessary and the popover doesn't dismiss until the user is done. This also allows complex interaction in the popover such as dragging sliders or entering text. Popovers are created with the form editor and are entirely customizable as result.

The present invention has a function called detents that tries to help the user to find good values. Based on the type of value being modifier, the user can easily get to exact angles or exact values of other types based on different unit systems such as SI or English distance units. In many places in the system the user may clicks down and drag to, change a value, and the system will pause briefly at good values. There is detent (or snap) at nice values, such as at 90 degrees or 100 percent which are large detents, or 45 degrees or 10 percent which are small detents. For example, while dragging an angle every mouse move is a step of half a degree except when it has a certain “nice” value. Then it performs no changes for a few mouse moves and then it starts again. The result is that interaction and changing of values pauses briefly at good numbers that the user might want so it makes it very easy to hit them. This also can be done with mini sliders, described below. The method involves causing the mouse pointer to vanish while the interaction is happening, so that the only feedback the user has is the changing of the value on the screen which the system can control directly, and not the position of the mouse pointer. When user releases the button the mouse pointer reappears, but at a location consistent with where the user thinks it should be, not necessarily where it would be if the mouse pointer had tracked the user's hand motion exactly.

Mini sliders let the user go through values that don't have a specific end point. A slider can be used to go between two end points, but for something that can have any value and doesn't have ends, the mini slider is used. Prior art systems utilize mini sliders, but the prior art systems don't have detents so that it pauses at nice values based on unit system. In an alternative embodiment, accelerator keys can be used to change values so that holding down keys causes dragging on a minislider to advance the value by coarser or finer steps, the steps again defined by the units for the value being changed (such as percent, SI distance units, English distance units, etc.).

Although an exemplary embodiment of the invention has been described above by way of example only, it will be understood by those skilled in the field that modifications may be made to the disclosed embodiment without departing from the scope of the invention.

What is claimed is:

1. A method of customizing user interfaces, the method comprising the steps of:
creating a generic viewport utilizing a blank display screen;
splitting the generic viewport into at least two viewports to create a layout of a customized interface; and
populating the at least two viewports on the fly to accommodate specifics part of a computer program.

2. The method of claim 1, wherein the at least two viewports are detached.

3. The method of claim 1, wherein the at least two viewport are embedded.

4. The method of claim 1, wherein the at least one viewport is selected from the group consisting of a tool bar, a list of data and a 3D model view.

5. A method of customizing a computer program, the method comprising the steps of:
creating at least one selection stack to track at least one selection type, where the type at the top of the at least one selection stack is the most recently selected;
specifying data packets to represent a single unit of selection; and
prioritizing the data packets based upon necessity of a user.

6. The method of claim 5, wherein the at least one type is comprised of at least one subsystem and wherein the at least one subsystem are different parts of the computer program.

7. The method of claim 5, wherein different views of the at least one selection stack can be utilized by different subsystems.

8. The method of claim 5, wherein a filter is utilized to view the at least one selection stack in a particular order.
